(19) United States
(12) Patent Application Publication
(10) Pub. No.: US 2026/0185949 A1
(43) Pub. Date: Jul. 2, 2026

(54) OPTICAL DETECTION SYSTEM AND METHOD FOR SEMICONDUCTOR SUBSTRATES

(71) Applicant: SPIROX CORPORATION, Hsinchu City (TW)

(72) Inventors: Yao-Chou Yang, Hsinchu City (TW); Feng-Chieh Li, Hsinchu City (TW); Yen-Cheng Chao, Hsinchu City (TW)

(21) Appl. No.: 19/203,981

(22) Filed: May 9, 2025

(30) Foreign Application Priority Data
Dec. 27, 2024 (TW) 113151359

(51) Int. Cl. G01N 21/95; G01N 21/88

(52) U.S. Cl. CPC G01N 21/9505; G01N 21/8806; G01N 21/8851; G01N 2021/8832; G01N 2201/0697

(57) ABSTRACT

An optical detection system and method for semiconductor substrates, wherein a sample is placed at a detection position and measurement is performed by directing an excitation light into the interior of the sample, a forward excitation signal being generated by directing the excitation light into the interior of the sample from a front side, and a backward excitation signal being generated by directing the excitation light into the interior of the sample and reflecting the excitation light by another interface of the sample. The optical detection system collects the forward excitation signal and the backward excitation signal, and a signal processing and image generation module generates high-resolution images of micro-hole wall shape and defects, thereby enabling accurate detection of internal structures in the interior of the micro-hole.

### CROSS REFERENCE TO RELATED APPLICATIONS

This application claims priority of Application No. 113 151 359 filed in Taiwan on Dec. 27, 2024 under 35 U.S.C. § 119, the entire contents of all of which are hereby incorporated by reference.

### TECHNICAL FIELD

The present invention relates to the field of optical detection of semiconductor substrates.

### BACKGROUND

In conventional optical experiments or imaging, excitation light is typically focused through optical lenses and directed onto a front side (light-facing side) of a sample, slightly penetrating into the sample, thereby inducing corresponding optical responses, such as scattering or reflection, on a surface or shallow interior portion of the sample. A primary limitation of this excitation approach is that excitation light is consistently directed toward the front side of the sample, preventing illumination of a back side or internal structures of the sample. Certain internal structures of the sample cannot be revealed by front-side excitation. In addition, since excitation light only illuminates the front side of the sample, structural or optical characteristics of the back side of the sample cannot be effectively excited or measured. This limitation significantly restricts the scope of measurement and detection for the sample in scenarios requiring data acquisition from different angles or depths. Conventional excitation-light illumination methods cannot provide comprehensive data of the sample, particularly as they may present certain limitations in deep structural analysis or in the detection of high-aspect-ratio micro-holes.

### SUMMARY OF THE INVENTION

In view of the above issues, the present invention proposes a solution primarily applicable to the detection of micro-holes with high aspect ratios. However, in practical applications, the solution may also be extended to the inspection of internal or back side of wafers or semiconductor substrates.

### Technical Features of the Present Invention

An optical detection system and method for semiconductor substrates, wherein a sample is placed at a detection position and measurement is performed by directing an excitation light into the interior of the sample, a forward excitation signal being generated by directing the excitation light into the interior of the sample from a front side, and a backward excitation signal being generated by directing the excitation light into the interior of the sample and reflecting the excitation light by another interface of the sample. The optical detection system collects the forward excitation signal and the backward excitation signal, and a signal processing and image generation module generates high-resolution images of micro-hole wall shape and defects, thereby enabling accurate detection of internal structures in the interior of the micro-hole.

An optical detection system and method for semiconductor substrates, wherein a sample is placed at a detection position, excitation light provided by a light source module being directed into a designated region of the sample from a front side to generate a forward excitation signal, and a backward excitation signal being generated by reflecting the excitation light by an interface disposed on a back side of the sample and directing the reflected excitation light into the interior of the same designated region from the back side. The optical detection system collects the forward excitation signal and the backward excitation signal, and a signal processing and image generation module generates high-resolution images of the shape and defects of a designated region of the sample, thereby enabling accurate detection of internal structures in the interior of the designated region of the sample.

### Effects of the Present Invention

The backward excitation: a portion of the excitation light penetrates the sample and returns from the back side of the sample, re-entering the sample.

The optical detection system separately records excitation signals from the front side and the back side of the sample, thereby achieving bidirectional signal acquisition. Information from both the front side and the back side of the sample is obtained, providing more comprehensive sample characteristics. Through analysis of the bidirectional signals, physical properties of the sample such as thickness, depth, or other related information.

Accurate representation of micro-hole structures enables clear presentation of the wall shape, dimensions, and defects of micro-holes, providing highly precise inspection results.

By combining the signals excited from the front side and the back side, a more comprehensive understanding of the internal structure of the micro-hole becomes possible.

Optical detection does not cause physical damage to the sample and is suitable for applications requiring high sample integrity.

A single sample can be detected multiple times, facilitating comparative analysis.

Various defects in the interior of the micro-hole, such as wall roughness and aperture non-uniformity, can be accurately located and identified.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic view of a first form of the sample of the present invention.

FIG. 2 is a schematic view of a second form of the sample of the present invention.

FIG. 3 is a block diagram of a first embodiment of the detection system of the present invention.

FIG. 4 is a schematic view of a first embodiment of the detection method of the present invention.

FIG. 5 is a block diagram of a second embodiment of the detection system of the present invention.

FIG. 6 is a schematic view of a second embodiment of the detection method of the present invention.

FIG. 7 is a schematic view of a third embodiment of the detection method of the present invention.

FIG. 8 is a schematic view of a fourth embodiment of the detection method of the present invention.

FIG. 9 is a first two-dimensional image of a micro-hole according to the present invention.

FIG. 10 is a second two-dimensional image of a micro-hole according to the present invention.

FIG. 11 is a three-dimensional image of a micro-hole according to the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained, unless the terms have a specific meaning in the present disclosure.

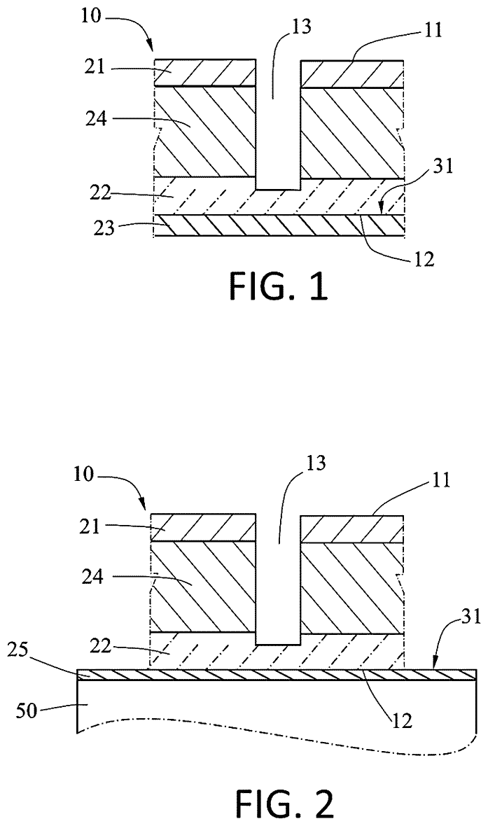

As shown in FIG. 1, regarding a first form of the sample 10 of the present invention, the sample 10 is a semiconductor 3D packaging structure comprising micro-holes 13 with high aspect ratio features, including but not limited to Through-Silicon Via (TSV) and Through-Glass Via (TGV). Component symbol 21 and component symbol 22 represent non-metal layers, typically insulating layers, photoresist layers, or other functional layers, which may be single-layer or multi-layer structures. Component symbol 23 represents an electrode layer, typically a metal layer 23. Component symbol 24 represents a silicon substrate. In the present invention, the electrode layer/metal layer 23 may serve as the interface 31. In addition, an interface between different media may also serve as the interface 31 for reversing the propagation direction of excitation light. Alternatively, the interface may comprise a structural layer capable of reflecting light, fixed to the back side or disposed in the interior of the sample.

As shown in FIG. 2, regarding a second form of the sample 10 of the present invention, the sample 10 is a semiconductor 3D packaging structure comprising micro-holes 13 with high aspect ratio features, including but not limited to Through-Silicon Via (TSV) and Through-Glass Via (TGV). Component symbol 21 and component symbol 22 represent non-metal layers, typically insulating layers, photoresist layers, or other functional layers, which may be single-layer or multi-layer structures. A reflective layer 25 is additionally disposed on a back side 12 of the sample 10, which may be selected from high-reflectivity mirrors, reflective materials, or thin films with specific optical properties. The reflective layer 25 is disposed on a surface of a stage 50 supporting the sample 10 and contacts the back side 12 of the sample 10. The reflective layer 25 is used as the interface 31 in the present invention.

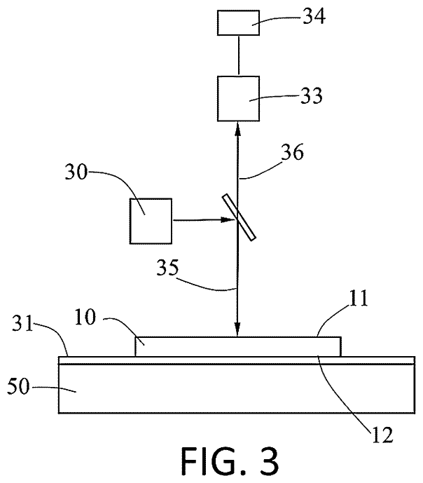

As shown in FIG. 3, a first embodiment of the detection system according to the present invention comprises:

A sample 10, a light source module 30, an interface 31, a photodetector 33, and a signal processing and image generation module 34.

The sample 10 is as described above and shown in FIGS. 1 and 2.

The light source module 30 provides an excitation light 35 with a wavelength range of about 1200 nm to about 1800 nm. The excitation light is an ultrafast laser. The excitation light 35 is focused and incident from a front side 11 of the sample 10 into the interior of the micro-hole 13, generating a forward excitation signal. The focusing technique may use one or more optical elements, including but not limited to lenses and mirrors, for precisely adjusting the focal position of the excitation light 35 to ensure accurate incidence into the micro-hole 13.

The interface 31, such as the metal layer 23 or reflective layer 25 of the sample 10 described previously, is disposed on the back side 12 of the sample 10 to reflect the excitation light 35 incident into the micro-hole 13, forming a backward excitation light 36 returning from the back side 12 into an interior portion of the micro-hole 13, generating a backward excitation signal. Further, the interface 31 may be designed with adjustable angles and variable reflectivity to adjust reflection efficiency.

The photodetector 33 receives the forward excitation signal and the backward excitation signal, and converts the forward excitation signal and the backward excitation signal into electrical signals. The photodetector 33 is selected from one or a combination of Photodiode (PD), Avalanche Photodiode (APD), Charge-Coupled Device (CCD), and Photomultiplier Tube (PMT). In the illustrative embodiment, the light source module 30 and photodetector 33 form a coaxial optical system.

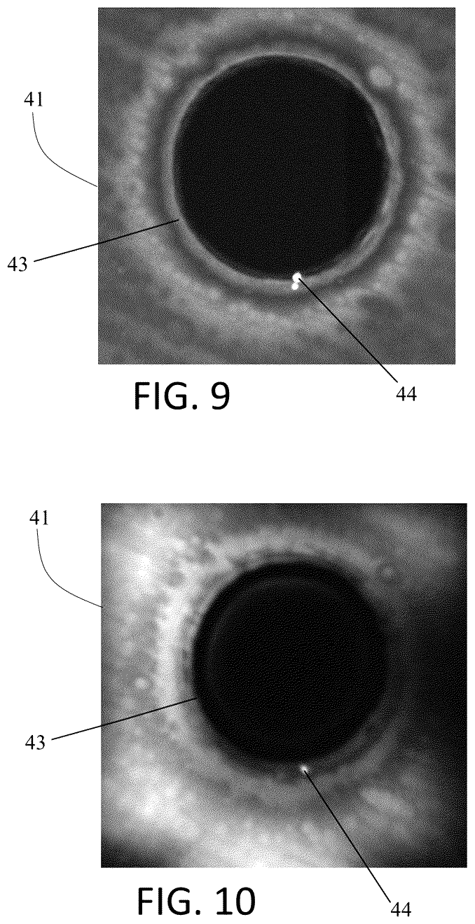

The signal processing and image generation module 34, coupled to the photodetector 33, acquires and processes electrical signals to generate a geometric structural image 41 of the micro-hole 13. The geometric structural image 41 presents a two-dimensional wall shape and defects of the micro-hole 13 with high-resolution features. As shown in FIGS. 9 and 10, a cross-sectional shape 43 of the micro-hole 13 is visualized, wherein a bright spot 44 represent a wall defects. The signal processing and image generation module 34 may include a digital signal processor, a high-performance computer, or dedicated firmware configured to perform real-time processing of the electrical signals received from the photodetector 33 and to generate a geometric structural image with high-resolution using algorithmic processing, and to further preform defect identification and quantitative analysis. The generated image of the micro-hole 13 enables the visualization of the wall shape of the micro-hole 13, the identification of wall defects of micro-hole 13 such as cracks, weak points, and material non-uniformities, and the provision of precise geometric structural information including the aperture size, the depth, and the shape characteristics.

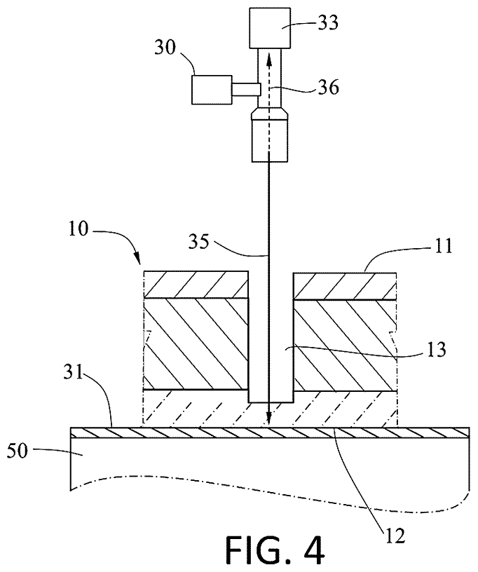

As shown in FIG. 4, the present invention implements an optical detection method based on the first embodiment described above, comprising:
Providing an excitation light 35 and focused the excitation light from a front side 11 of a sample 10 into an interior portion of micro-hole 13 having high aspect ratio features, thereby generating a forward excitation signal.
Providing an interface 31 on the back side 12 of the sample 10, reflecting the excitation light 35 incident into the micro-hole 13 to form a backward excitation light 36, returning into the micro-hole 13, thereby generating a backward excitation signal.
Receiving the forward excitation signal and the backward excitation signal and converting the forward excitation signal and the backward excitation signal into electrical signals. and
Generating an image of a two-dimensional wall shape and defects of the micro-hole based on the electrical signals.

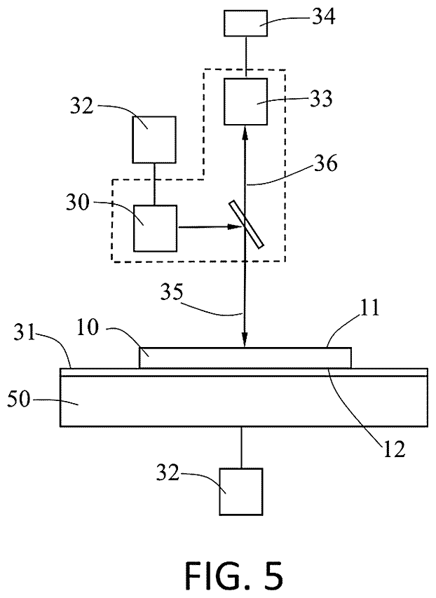

As shown in FIG. 5, a second embodiment of the detection system according to the present invention comprises:

A sample 10, a light source module 30, an interface 31, a vertical-axis driving module 32, a photodetector 33, and a signal processing and image generation module 34.

The sample 10 is as previously described and shown in FIG. 1 and FIG. 2.

The light source module 30 provides an excitation light 35 with a wavelength range of about 1200 nm to about 1800 nm. The excitation light is an ultrafast laser. The excitation light 35 is focused and incident from a front side 11 of the sample 10 into the interior of the micro-hole 13, generating a forward excitation signal. The focusing technique may use one or more optical elements, including but not limited to lenses and mirrors, for precisely adjusting the focal position of the excitation light 35 to ensure accurate incidence into the micro-hole 13.

The interface 31, such as the metal layer 23 or reflective layer 25 of the sample 10 described previously, is disposed on the back side 12 of the sample 10 to reflect the excitation light 35 incident into the micro-hole 13, forming a backward excitation light 36 returning from the back side 12 into an interior portion of the micro-hole 13, generating a backward excitation signal. Further, the interface 31 may be designed with adjustable angles and variable reflectivity to adjust reflection efficiency.

The vertical-axis driving module 32 configured to control one or a combination of the light source module 30, the photodetector 33 and associated optical components (as enclosed by the dashed lines in FIG. 5), and the sample, to move along a vertical axis. During the movement along the driving direction, the forward excitation signal and the backward excitation signal of the micro-hole are generated layer-by-layer. The vertical-axis driving module 32 may include a movement mechanism, a guiding system, and a precision position control device to achieve the above-described accurate vertical movement, perform layer-by-layer scanning, acquiring a comprehensive structural signal of the micro-hole 13.

The photodetector 33 receives the forward excitation signal and the backward excitation signal, and converts the forward excitation signal and the backward excitation signal into electrical signals. The photodetector 33 is selected from one or a combination of Photodiode (PD), Avalanche Photodiode (APD), Charge-Coupled Device (CCD), and Photomultiplier Tube (PMT). In the illustrative embodiment, the light source module 30 and photodetector 33 form a coaxial optical system.

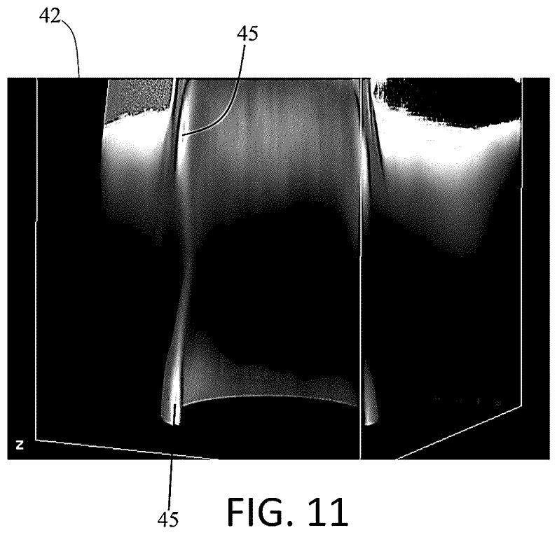

The signal processing and image generation module 34, coupled to the photodetector 33, is configured to acquires and processes electrical signals to generate a geometric structural image 42 of the micro-hole 13. The geometric structural image 42 presents a three-dimensional wall shape and defects of the micro-hole 13 with high-resolution features. As shown in FIG. 11, a slightly curved high-brightness line 45 represents the longitudinal wall shape of the micro-hole 13. The signal processing and image generation module 34 may include a digital signal processor, a high-performance computer, or dedicated firmware configured to perform real-time processing of the electrical signals received from the photodetector 33 and to generate a geometric structural image with high-resolution using algorithmic processing, and to further preform defect identification and quantitative analysis. The generated image of the micro-hole 13 enables the visualization of the wall shape of the micro-hole 13, the identification of wall defects of micro-hole 13 such as cracks, weak points, and material non-uniformities, and the provision of precise geometric structural information including the aperture size, the depth, and the shape characteristics.

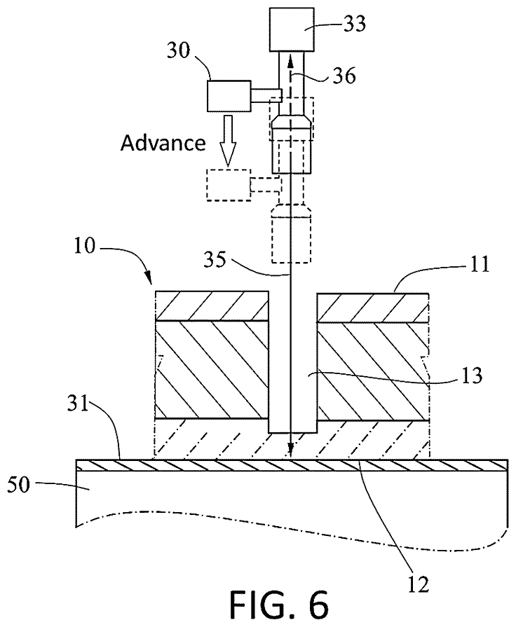

As shown in FIG. 6, the present invention implements an optical detection method based on the second embodiment described above, comprising:
Providing an excitation light 35 and focusing the excitation light from a front side 11 of a sample 10 into the interior of a micro-hole 13 having high aspect ratio features, thereby generating a forward excitation signal.
Providing an interface 31 on the back side 12 of the sample 10, reflecting the excitation light 35 incident into the micro-hole 13 to form a backward excitation light 36, returning into the interior of the micro-hole 13, thereby generating a backward excitation signal.
controlling one or a combination of the excitation light 35, associated optical components, and the sample 10 to moving along a vertical axis to generate the forward excitation signal and the backward excitation signal layer-by-layer.
Receiving the forward excitation signal and the backward excitation signal and converting the forward excitation signal and the backward excitation signal into electrical signals. and
Generating an image of the three-dimensional wall shape and defects of the micro-hole 13 based on these electrical signals.

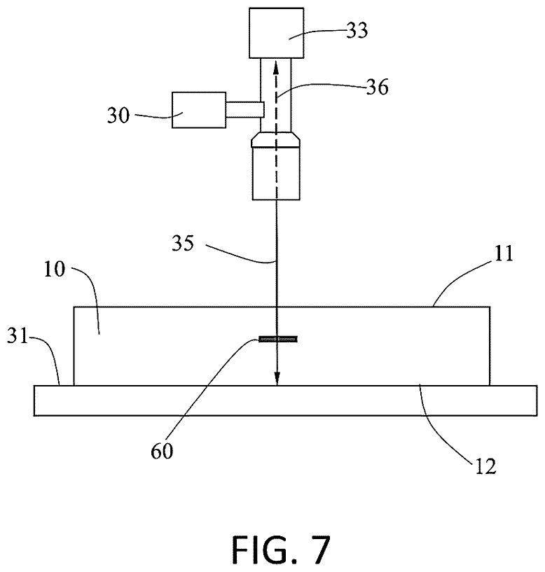

As shown in FIG. 7, a third embodiment of the present invention includes a sample 10 formed of an optically transparent material, including but not limited to silicon. In this embodiment, the sample 10 is supported by a stage 50, and the stage 50 includes an interface 31 in contact with the sample 10.

According to a third embodiment, a detection method for detection of internal defects in semiconductor substrates is provided. The method comprises:
Providing an excitation light 35 and focusing excitation light 35 to be incident onto a designated region 60 of the sample 10 from front side 11 of sample 10, thereby generating a forward excitation signal from designated region 60; the interface 31 reflects the excitation light 35 penetrating through the sample 10 to form backward excitation light 36. The backward excitation light 36 returns from a back side 12 of the sample 10 to the designated region 60, thereby generating a backward excitation signal from the designated region 60; receiving the forward excitation signal and the backward excitation signal and converting the forward excitation signal and the backward excitation signal into electrical signals; and generating a two-dimensional image of the designated region 60 based on the electrical signals.
In the third embodiment, as illustrated, the excitation light 35 and the backward excitation light 36 are coaxial.

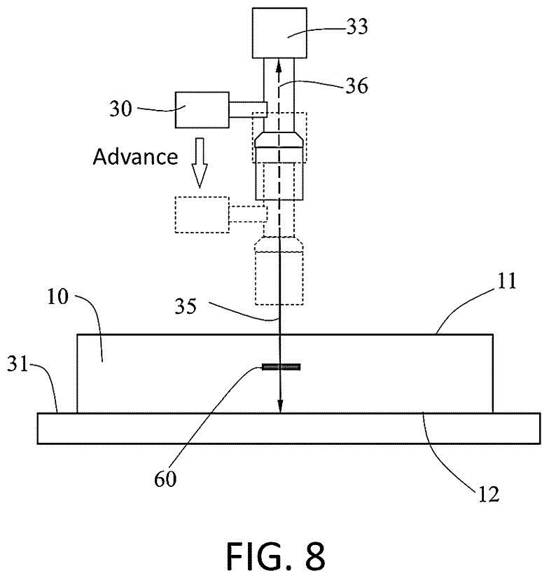

As shown in FIG. 8, a fourth embodiment of the invention provides a sample 10 comprising optically transparent materials, including but not limited to silicon. In this embodiment, the sample 10 is supported by a stage 50, and the stage 50 having an interface 31 in contact with the sample 10.

According to the fourth embodiment on the invention, a detection method is provided for detecting internal defects of semiconductor materials or packaging substrates. The method comprises:
Providing the excitation light 35 and focusing the excitation light 35 to be incident onto a designated region 60 of a sample 10 from a front side 11 of the sample 10, thereby generating a forward excitation signal from the designated region 60; the interface 31 reflecting the excitation light 35 penetrating through the sample 10 to form backward excitation light 36, the backward excitation light 36 returning from a back side 12 of the sample 10 to the designated region 60, thereby generating a backward excitation signal from the designated region 60; controlling one or a combination of the excitation light 35, associated optical components, and the sample 10 to move along a vertical axis, thereby generating the forward excitation signal and the backward excitation signal from the designated region 60 layer by layer; receiving the forward excitation signal and the backward excitation signal and converting the forward excitation signal and the backward excitation signal into electrical signals; and generating a three-dimensional image of the designated region 60 based on the electrical signals.

In the fourth embodiment, as illustrated, the excitation light 35 and the backward excitation light 36 are coaxial.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. An optical detecting system for semiconductor substrates, comprising:
a sample positioned at an inspection location;
a light source module configured to provide an excitation light, wherein the excitation light is incident from a front side of the sample into an interior portion of a micro-hole having a high aspect ratio feature, thereby generating a forward excitation signal;
an interface configured to reflect the excitation light incident into the micro-hole, forming a backward excitation light returning from a back side of the sample into the interior of the micro-hole, thereby generating a backward excitation signal;
a photodetector configured to receive the forward excitation signal and the backward excitation signal and to convert the forward excitation signal and the backward excitation signal into electrical signals; and
a signal processing and image generation module coupled to the photodetector and configured to acquire and process said electrical signals and generate a geometric structural image of the micro-hole, the geometric structural image presenting forward and backward two-dimensional shapes and defects of micro-hole sidewalls with high-resolution features.

2. The optical detecting system for semiconductor substrates according to claim 1, wherein the interface comprises a reflective layer disposed in the interior of a structure of the sample.

3. The optical detecting system for semiconductor substrates according to claim 1 wherein the interface comprises a reflective layer disposed on a surface of a stage, the reflective layer supporting the back of the sample.

4. The optical detecting system for semiconductor substrates according to claim 1, wherein the interface comprises a structural layer capable of reflecting light and fixed onto the back side or in the interior of the sample.

5. The optical detecting system for semiconductor substrates according to claim 1, wherein the photodetector is selected from one or a combination of Photodiode (PD), Avalanche Photodiode (APD), Charge-Coupled Device (CCD), and Photomultiplier Tube (PMT).

6. The optical detecting system for semiconductor substrates according to claim 1, wherein the excitation light has a wavelength ranging from about 1200 to about 1800 nm.

7. The optical detecting system for semiconductor substrates according to claim 1, wherein the excitation light comprises an ultrafast laser.

8. The optical detecting system for semiconductor substrates according to claim 1, wherein the light source module and the photodetector form a coaxial system.

9. An optical detecting system for semiconductor substrates, comprising:
a sample positioned at an inspection location;
a light source module configured to provide an excitation light, wherein the excitation light is incident from a front side of the sample into an interior of a micro-hole having a high aspect ratio feature, thereby generating a forward excitation signal;
an interface configured to reflect the excitation light incident into the micro-hole, forming a backward excitation light returning into the interior of the micro-hole, thereby generating a backward excitation signal;
a photodetector configured to receive the forward excitation signal and the backward excitation signal and to convert the forward excitation signal and the backward excitation signal into electrical signals;
a vertical-axis driving module configured to control one or a combination of the light source module, the photodetector and associated optical components, and the sample, to move along a vertical axis, generating the forward excitation signal and the backward excitation signal of the micro-hole layer-by-layer along a moving direction; and
a signal processing and image generation module coupled to the photodetector and configured to acquire and process the electrical signals and generate a geometric structural image of the micro-hole, the geometric structural image presenting a three-dimensional wall shape and defects of the micro-hole with high-resolution features.

10. The optical detecting system for semiconductor substrates according to claim 9, wherein the interface comprises a reflective layer disposed in the interior of a structure of the sample.

11. The optical detecting system for semiconductor substrates according to claim 9 wherein the interface comprises a reflective layer disposed on a surface of a stage, the reflective layer supporting the back side of the sample.

12. The optical detecting system for semiconductor substrates according to claim 9, wherein the interface comprises a structural layer capable of reflecting light and fixed onto the back side or in the interior of the sample.

13. The optical detecting system for semiconductor substrates according to claim 9, wherein the photodetector is selected from one or a combination of Photodiode (PD), Avalanche Photodiode (APD), Charge-Coupled Device (CCD), and Photomultiplier Tube (PMT).

14. The optical detecting system for semiconductor substrates according to claim 9 wherein the excitation light has a wavelength ranging from about 1200 to about 1800 nm.

15. The optical detecting system for semiconductor substrates according to claim 9, wherein the excitation light comprises an ultrafast laser.

16. The optical detecting system for semiconductor substrates according to claim 9, wherein the light source module and the photodetector form a coaxial system.

17. An optical detecting method for semiconductor substrates, comprising:
providing an excitation light and directing the excitation light from a front side of a sample into an interior of a micro-hole having a high aspect ratio feature, thereby generating a forward excitation signal;
providing an interface configured to reflect the excitation light incident into the micro-hole, forming backward excitation light returning into the interior of the micro-hole, thereby generating a backward excitation signal;
receiving the forward excitation signal and the backward excitation signal and converting the forward excitation signal and the backward excitation signal into electrical signals; and
generating an image of a two-dimensional wall shape and defects of the micro-hole based on the electrical signals.

18. The optical detecting method for semiconductor substrates according to claim 17, wherein the excitation light and the backward excitation light are coaxial.

19. An optical detecting method for semiconductor substrates, comprising:
providing an excitation light and directing the excitation light from a front side of a sample into an interior portion of a micro-hole having a high aspect ratio feature, thereby generating a forward excitation signal;
providing an interface configured to reflect the excitation light incident into the micro-hole, forming backward excitation light returning into the interior portion of the micro-hole, thereby generating a backward excitation signal;
controlling one or a combination of the excitation light and associated optical components, and the sample, to move along a vertical axis, thereby generating the forward excitation signal and backward excitation signal of the micro-hole, layer-by-layer;
receiving the forward excitation signal and backward excitation signal and converting the forward excitation signal and backward excitation signal into electrical signals; and
generating an image of a three-dimensional wall shape and defects of the micro-hole based on the electrical signals.

20. The optical detecting method for semiconductor substrates according to claim 19, wherein the excitation light and the backward excitation light are coaxial.

21. An optical detecting method for semiconductor substrates, comprising:
providing excitation light and directing the excitation light onto a designated region from a front side of a sample, thereby generating a forward excitation signal of the designated region;
providing an interface configured to reflect the excitation light, forming backward excitation light returning to the designated region, thereby generating a backward excitation signal of the designated region;
receiving the forward excitation signal and backward excitation signal and converting the forward excitation signal and backward excitation signal into electrical signals; and
generating an image of the designated region based on the electrical signals.

22. The optical detecting method for semiconductor substrates according to claim 21, wherein the excitation light and the backward excitation light are coaxial.

23. An optical detecting method for semiconductor substrates, comprising:
providing excitation light and directing the excitation light onto a designated region from a front side of a sample, thereby generating a forward excitation signal of the designated region;
providing an interface configured to reflect the excitation light, forming backward excitation light returning to the designated region, thereby generating a backward excitation signal of the designated region;
controlling one or a combination of the excitation light and associated optical components, and the sample, to move along a vertical axis, thereby generating the forward excitation signal and backward excitation signal of the designated region, layer-by-layer;
receiving the forward excitation signal and backward excitation signal and converting the forward excitation signal and backward excitation signal into electrical signals; and
generating a three-dimensional image of the designated region based on the electrical signals.

24. The optical detecting method for semiconductor substrates according to claim 23, wherein the excitation light and the backward excitation light are coaxial.
